(19) United States
(12) Patent Application Publication
(10) Pub. No.: US 2015/0159806 A1
(43) Pub. Date: Jun. 11, 2015

(54) PRESSURE VESSEL WITH METALLIC LINER AND TWO FIBER LAYERS OF DIFFERENT MATERIAL

(71) Applicants: Francesco Nettis, London (GB); Paolo Redondi, Milano (IT); Vanni Neri Tomaselli, Luxembourg (LU)

(72) Inventors: Francesco Nettis, London (GB); Paolo Redondi, Milano (IT); Vanni Neri Tomaselli, Luxembourg (LU)

(73) Assignee: BLUE WAVE CO S.A., Luxembourg (LU)

(21) Appl. No.: 14/363,273

(22) PCT Filed: Dec. 5, 2011
(86) PCT No.: PCT/EP2011/071794

§ 371 Date: Nov. 24, 2014

(51) Int. Cl. F17C 1/00; F17C 1/14

(52) U.S. Cl. CPC F17C 1/002; F17C 1/14; F17C 2201/0109; F17C 2201/054; F17C 2203/0604; F17C 2203/0631; F17C 2203/0643; F17C 2203/0639; F17C 2203/0648; F17C 2203/0663; F17C 2205/0134; F17C 2260/053; F17C 2205/0379; F17C 2270/0105

(57) ABSTRACT

The present invention relates to a pressure vessel for containing or transporting pressurized gas. More particularly it relates to such vessels for containing or transporting compressed natural gas. The present invention also relates to a method of storing or transporting gas onshore or offshore. Moreover, the present invention relates to a vehicle for transporting gas, in particular compressed natural gas.

### FIELD OF THE INVENTION

The present invention relates to a pressure vessel for containing or transporting pressurized gas. More particularly it relates to such vessels for containing or transporting compressed natural gas (CNG).

The present invention also relates to a method of storing or transporting gas onshore or offshore. Moreover, the present invention relates to a vehicle for transporting gas, in particular compressed natural gas.

### BACKGROUND ART

Conventional pressure vessels for containing or transporting pressurized gas are typically made on the basis of stainless steel and are heavy in weight. However, the cost of stainless steel is considerable, whereby despite its corrosion resistant properties, it presents difficulties on seafaring vehicles—seafaring vessels have a load-bearing limit based upon the buoyancy of the vehicle, much of which load capacity is taken up by the physical weight of the vessels—i.e. their “empty” weight.

Moreover, on seafaring vehicles, inevitable salt water spray creates an undesired and prolonged galvanic coupling between the stainless steel in the pressure vessel and the carbon steel used for the ship structure. This coupling leads to the so-called marine corrosion, which over time deteriorates the metal with the higher difference in, or stronger, electronegativity.

### Technical Problem to be Solved

The present invention therefore aims at overcoming or alleviating at least one of the disadvantages of the known pressure vessels.

In particular, an object of the present invention is to provide pressure vessels, which are more resistant to the conditions onboard seafaring vehicles.

### SUMMARY OF THE INVENTION

In a first aspect of the present invention a pressure vessel is proposed, in particular for compressed natural gas containment or transport. The pressure vessel has a generally cylindrical shape over a majority of its length and at least one opening for gas loading and offloading and for liquid evacuation. The pressure vessel comprises a metallic liner, a first fiber layer external and adjacent to the metallic liner, and a second fiber layer external and adjacent to the first fiber layer. The first and second fiber layers are made of different materials.

Preferably the opening is at the bottom of the vessel. Preferably the vessel is for standing vertically, such that the cylindrical section thereof is substantially vertical.

The metallic liner may be gas impermeable and/or corrosion resistant.

The metallic liner may be selected from the group comprising steel, stainless steel, nickel-based alloys, bi-phase steel, aluminum, aluminum alloys, titanium, and titanium alloys.

Either or both of the fiber layers may be made of fibers wound about the metallic liner.

The first fiber layer may comprise carbon fibers.

The second fiber layer may comprise glass fibers.

The pressure vessel may be of essentially cylindrical shape, inside and outside, along that majority of its length.

The inner diameter of the pressure vessel may be between 0.5 meters and 5 meters.

The inner diameter of the pressure vessel may be between 1.5 meters and 3.5 meters.

The pressure vessel may further comprise a manhole for entering and/or inspecting the interior of the vessel. Preferably the manhole is at the top of the vessel. The manhole may be a 24 inch (60 cm) manhole, or equivalent, for allowing internal inspection, e.g. by a person climbing into the vessel. The manhole may have closing means for allowing sealed closing of the opening thereof.

A plurality of the inspectable pressure vessels (10) can be arranged in a module or compartment, and the pressure vessels can be interconnected for loading and offloading operations.

Preferably the vessels all have the same height. Some may have different heights, however, to accommodate a variable floor condition—such as the curvature of a hull of a ship.

According to a second aspect of the invention there is provided a method of storing or transporting gas onshore or offshore, in particular compressed natural gas, using at least one pressure vessel as described above.

A third aspect of the present invention proposes a vehicle for transporting gas, in particular compressed natural gas, comprising at least one vessel as described above.

The gas transporting vehicle may be a ship or some other form of transporter, such as a truck or a train.

In the gas transporting vehicle, the pressure vessels may be interconnected.

### Advantages of the Invention

The pressure vessel according to the present invention may allow a reduction in the unit cost in production, compared to equivalent steel vessels.

A pressure vessel according to the present invention may also allow a reduction in the galvanic coupling between the vessels and a seafaring vehicle transporting them as compared to steel vessels.

A further advantage of the present invention may be a reduction in the weight of the pressure vessel compared to equivalent steel vessels—a reduced weight allows a greater volume of fluid to be carried by a ship since ships have a given buoyancy for a given displacement.

### BRIEF DESCRIPTION OF THE DRAWINGS

These and other features of the present invention will now be described, purely by way of example, with reference to the accompanying drawings, in which:

FIG. 1 is a schematic cross section of an embodiment of a pressure vessel in accordance with the present invention;

FIG. 2. is a schematic perspective view showing interconnecting piping between vessels according to the invention, arranged in a module;

FIG. 3 is a schematic side view showing the interconnecting piping between vessels lined up within a module;

FIG. 4 is a schematic top view showing the interconnecting piping between vessels lined up within a module;

FIG. 5 schematically shows a section through a ship hull showing two modules arranged side by side; and

FIG. 6 schematically shows a more detailed view of the top-side pipework.

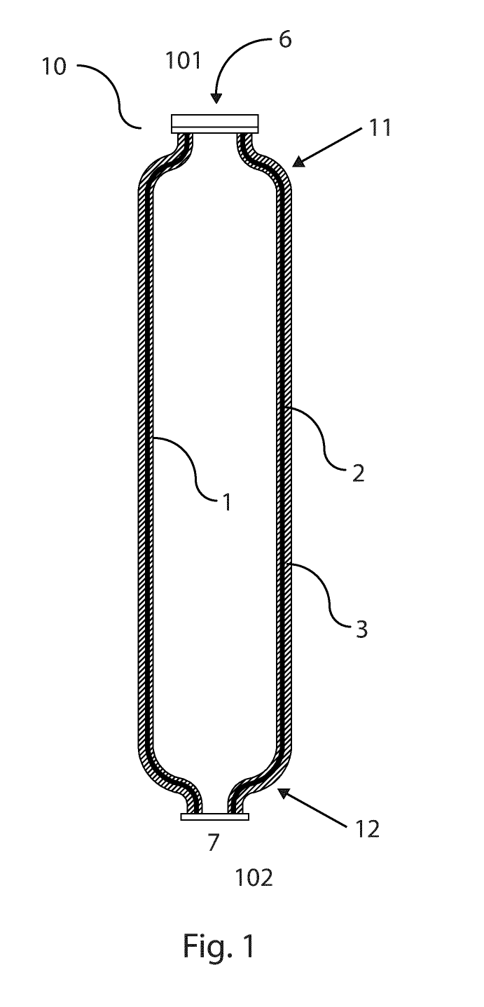

### DETAILED DESCRIPTION OF THE INVENTION

Increased capacity and efficiency requests in the field of CNG transportation, and the common use of steel-based cylinders therefor, has led to the development of steel-based cylinders with a thicker structure, which usually results in a heavy device or a device with a lower mass ratio of transported gas to containment system. This effect can be overcome with the use of advanced and lighter materials such as composite structures.

Some existing solutions therefore already use composite structures in order to reduce the weight of the device, but the size and configuration of the composite structures are not optimized, for example due to the limitations of the materials used. For example, the use of small cylinders or non-traditional shapes of vessel often leads to a lower efficiency in terms of transported gas (smaller vessels can lead to higher non-occupied space ratios) and a more difficult inspection of the inside of the vessels. Further, the use of partial wrapping (e.g. hoop-wrapped cylinders) for covering only the cylindrical part of the vessel, but not the ends of it, leads to an interface existing between the wrapped portion of the vessel and the end of the vessel where only the metal shell is exposed. That too can lead to problems, such as corrosion.

Also, transitions between materials in a continuous structural part usually constitute weaker areas, and hence the points in which failures are more likely to occur.

The vessels mentioned in this patent are made of an internal metal liner 1 capable of hydraulic or fluidic containment of raw gases. The metal liner 1 is not needed to be provided in a form to provide a structural aim, during CNG transportation, loading and offloading phases.

The metallic liner 1 should be corrosion-proof and capable of carrying non-treated or unprocessed gas, hence the used material should be stainless steel, aluminum or other corrosion-proof metallic alloy.

In case of stainless steel, it is preferred but not limited to the use of an austenitic stainless steel such as AISI 304, 314, 316 or 316L (with low carbon percentages).

In case of other metallic alloys, it is recommended but not limited to the use of a Nickel-based alloy or an aluminum-based alloy capable of corrosion resistance.

This construction also allows the vessel to be able to carry other gases, such as natural gas (methane) with CO₂ allowances of up to 14% molar, and/or H₂S allowances of up to 1.5% molar, and also such as H₂ and/or CO₂ gases. The preferred use, however, is CNG transportation.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state.

The liner 1 preferably only needs to be strong enough to withstand the stresses arising from manufacturing processes of the vessel, such as those imposed thereon during fiber winding. The structural support during pressurized transportation of gas will instead be provided by the external composite layer(s) 2, 3.

The first fiber layer 2 about the liner 1, according to the illustrated embodiment, is a fiber-reinforced polymer based on carbon/graphite. It substantially is fully wrapping the vessel (including most of the vessel ends) and it is arranged to be providing the structural contribution during service. Is it preferred but not limited to the use of a carbon yarn, preferably with a tensile strength of 3,200 MPa or higher and/or a preferred Young Modulus of 230 GPa or higher. Advantageously it can have 12,000, 24,000 or 48,000 filaments per yarn.

The second fiber layer 3, according to the illustrated embodiment, has an isolating and protective function. In use it will be in direct contact with the external environment. For these mentioned reasons, the second external fiber layer 3 can preferably be a polymer or a fiber-reinforced polymer based on glass fibers, due to its inert behavior in aggressive and marine environments, and due to its isolating properties in terms of low thermal conductivity. Is it preferred but not limited to the use of an E-glass or S-glass fiber. Preferably the fibers have a suggested tensile strength of 1,000 MPa or higher and/or a suggested Young Modulus of 70 GPa or higher.

The composite matrix, regardless of the composite layer considered, is preferred to be a polymeric resin thermoset or thermoplastic. More precisely, if a thermoset, it could be and epoxy-based resin, or alternatively a vinylester or polyester-based resin. This allows a cost reduction compared to other possible arrangements, including the traditional steel arrangement.

The manufacturing of the external composite layer 2, 3 over the said metallic liner 1 preferably involves a winding technology. This can potentially gives a high efficiency in terms of production hours. Moreover it can potentially provide good precision in the fibers' orientation. Further it can provide good quality reproducibility.

The reinforcing fibers preferably are wound with a back-tension over a mandrel. The mandrel is typically the liner. The liner thus constitutes the male mould for this technology. The winding is typically after the fibers have been pre-impregnated in the resin. Impregnated fibers are thus preferably deposited in layers over said metallic liner until the desired thickness is reached for the given diameter. For example, for a diameter of 6 m, the desired thickness might be about 350 mm for carbon-based composites or about 650 mm for glass-based composites.

Since this invention preferably relates to a substantially fully-wrapped pressure vessel 10, a multi-axis crosshead for fibers is preferably used in the manufacturing process.

The process preferably includes a covering of at least most of the ends 11, 12 of the pressure vessel 10 with the structural external composite layer 2, 3.

In the case of the use of thermoset resins there can be a use of an impregnating basket before the fiber deposition—for impregnating the fibers before actually winding the fibers around the metal liner 1.

In the case of the use of thermoplastic resins, there can be a heating of the resin before the fiber deposition in order to melt the resin just before reaching the mandrel, or the fibers are impregnated with thermoplastic resin before they are deposited as a composite material on the metal liner. The resin is again heated before depositing the fibers in order to melt the resin just before the fiber and resin composite reaches the metal liner.

The pressure vessel 10 has an opening 7 (here provided with a cap or connector) addressed to gas loading and offloading and for liquid evacuation. It is at a bottom end 12 thereof and it can be a 12-inch (30 cm) opening for connecting to pipework.

The vessel 10 also has an opening 6 at the top end 11. It is shown to be in the form of an 18 inch (45 cm) wide or above access manhole, such as one with a sealed or sealable cover (or more preferably a 24 inch (60 cm) manhole). It is preferably provided according to ASME (American Society of Mechanical Engineers) standards. Preferably the opening is provided with closing means, allowing sealed closing of the opening, and for allowing internal inspection when the vessel 10 is not in use, such as by a person climbing into the vessel through the opening/manhole.

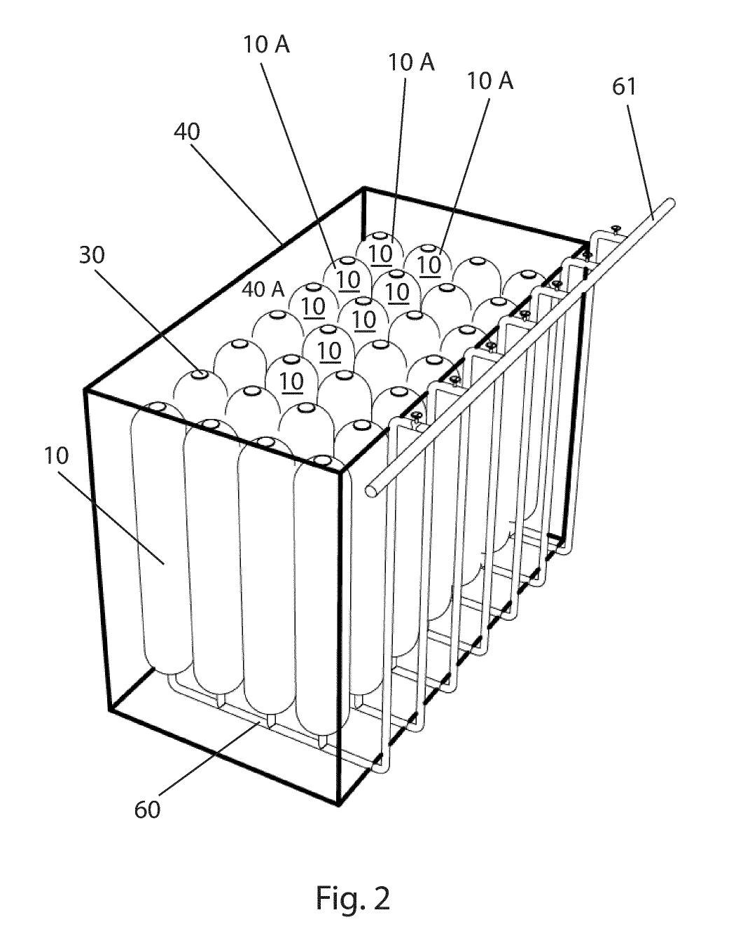

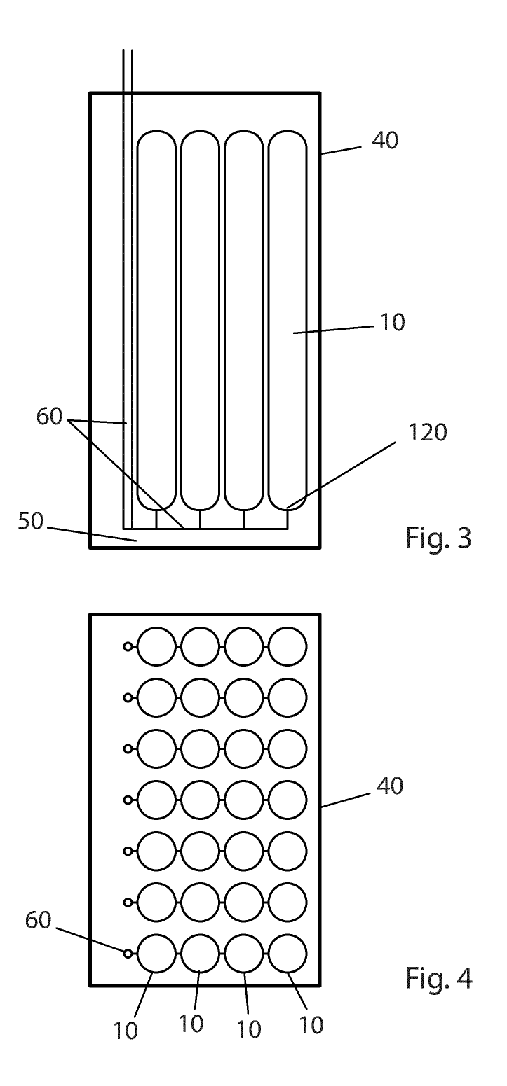

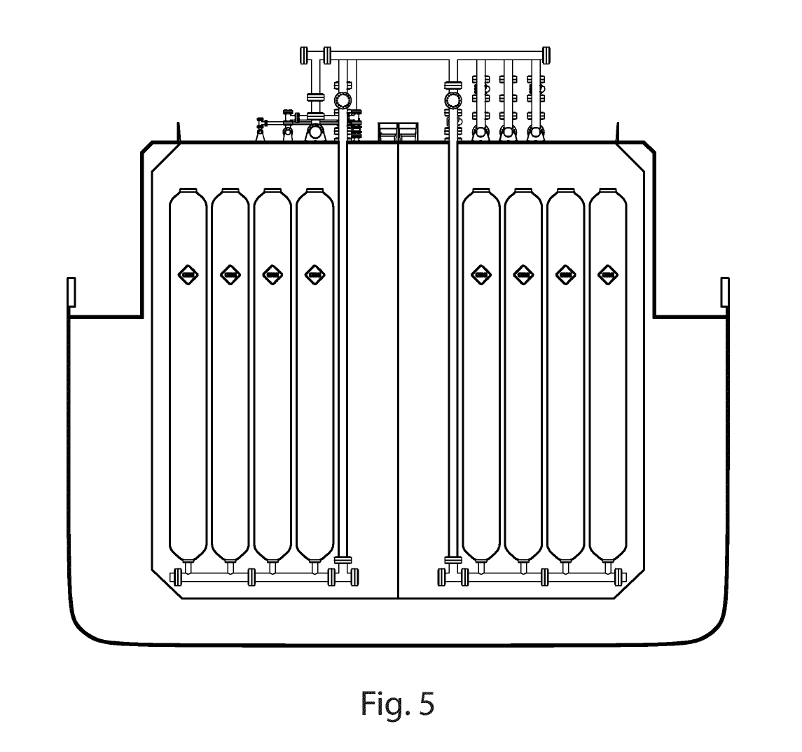

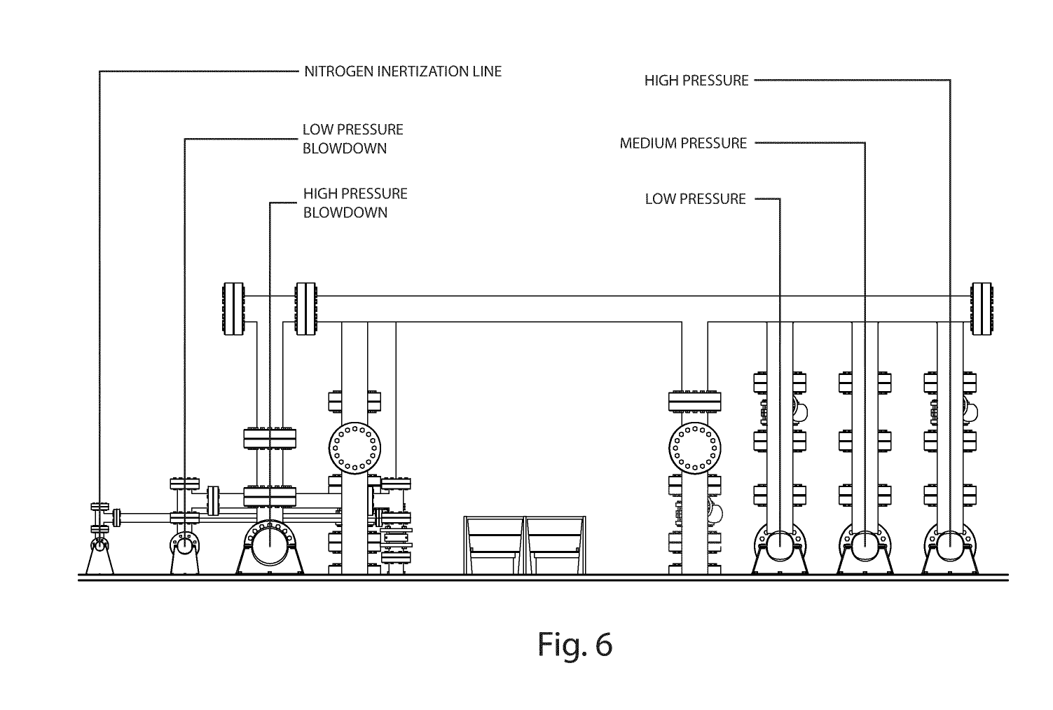

The pressure vessels can be arranged in a ship's hull in modules or compartments 40—see FIG. 2—and can be interconnected for loading and offloading operations, such as via pipework 61. In a preferred configuration, such modules or compartments 40 have four edges (are quadrilateral shaped) and contain a plurality of vessels 10. The number of vessels chosen will depend upon the vessel diameter or shape and the size of the modules or compartments 40. Further, the number of modules or compartments will depend upon the structural constraints of the ship hull for accommodating the modules or compartments 40. It is not essential for all the modules or compartments to be of the same size or shape, and likewise they need not contain the same size or shape of pressure vessel, or the same numbers thereof.

The vessels 10 may be in a regular array within the modules or compartments—in the illustrated embodiment a 4×7 array. Other array sizes are also to be anticipated, whether in the same module (i.e. with differently sized pressure vessels), or in differently sized modules, and the arrangements can be chosen or designed to fit appropriately in the ship's hull.

For external inspection-ability reasons the distance between the vessels 10 within the modules or compartments will be at least 380 mm, or more preferably at least 600 mm. These distances also allow space for vessel expansion when loaded with the pressurised gas—the vessels may expand by 2% or more in volume when loaded (and changes in the ambient temperature can also cause the vessel to change their volume).

Preferably the distance between the modules or compartments 40 or between the outer vessels 10A and the walls or boundaries 40A of the modules or compartments 40, or between adjacent outer vessels of neighbouring modules or compartments 40 (such as where no physical wall separates neighbouring modules or compartments 40) will be at least 600 mm, or more preferably at least 1 meter, again for external inspection-ability reasons, and/or to allow for vessel expansion.

Each pressure vessel row (or column) is interconnected with a piping system intended for loading and offloading operations from the bottom 12 of each vessel 10, such as through the preferably 12 inch (30 cm) opening 7. The connection is to main headers, such as through motorized valves.

The main headers can comprise various different pressure levels, for example three of them (high—e.g. 250 bar, medium—e.g. 150 bar and low—e.g. 90 bar), plus one blow down header and one nitrogen header for inert purposes.

Also as shown in FIG. 4, the vessels 10 are preferred to be mounted vertically, preferably on dedicated supports or brackets, or by being strapped into place. The supports (not shown) hold the vessels 10 in order to avoid horizontal displacement of the vessels relative to one another. Clamps, brackets or other conventional pressure vessel retention systems, may be used for this purpose, such as hoops or straps that secure the main cylinder of each vessel.

The supports can be designed to accommodate vessel expansion, such as by having some resilience.

Vertically-mounted vessels can give less criticality in following dynamic loads due to a ship motion and/or can allow an easier possible replacement of single vessels in a module or compartment (they can be lifted out without the need to first remove other vessels from above) and/or a fast installation time. Mounting vessels in a vertical position can also allow possible condensed liquids to fall, under the influence of gravity, to the bottom of the vessels, thereby being off-loadable the vessels using, e.g., the 12 inch opening 7 at the bottom 12 of each vessel 10.

Offloading of the gas will advantageously be also from the bottom of the vessel 10.

With the majority of the piping and valving 60 being installed towards the bottom of the modules 40, the center of gravity of the whole arrangement will be also in a low position, which is recommended or preferred, especially for improving stability at sea, or during gas transportation.

Modules or compartments 40 are preferably kept in a controlled environment with nitrogen gas being between the vessels and the module walls 40A, thus helping to prevent fire occurrence. Alternatively, the engine exhaust gas could be used for this inerting function thanks to its composition being rich in CO₂.

Maximization of the size of the individual vessels 10, such as by making them, for example, up to 6 meter in diameter and up to 30 meter in length, for the same total volume contained allows a designer to reduce the total number of vessels, and it allows a reduction in the connection and inter-piping complexity, and hence the number of possible leakage points—they usually occur in weaker locations such as weldings, joints and manifolds. Preferred arrangements call for diameters of at least 2 m.

One dedicated module can be set aside for liquid storage (such as condensate) using the same concept of interconnection used for the gas storage. The modules are thus potentially all connected together to allow a distribution of such liquid from other modules 40 to the dedicated module—a ship will typically feature multiple modules.

In and out gas storage piping may advantageously be linked with at least one of metering, heating, and/or blow down systems and scavenging systems through valve-connected manifolds. They may preferably be remotely activated by a Distributed Control System (DCS).

Piping diameters are preferably as follows:
18 inch. for the three main headers (low, medium and high pressure) dedicated to CNG loading/offloading.
24 inch. for the blow-down CNG line.
6 inch. for the pipe feeding the module with the inert gas.
10 inch. for the blow-down inert gas line.
10 inch. for the pipe dedicated to possible liquid loading/offloading.

All modules are preferably equipped with adequate firefighting systems, as foreseen by international codes, standards and rules.

The transported CNG will typically be at a pressure in excess of 60 bar, and potentially in excess of 100 bar, 150 bar, 200 bar or 250 bar, and potentially peaking at 300 bar or 350 bar.

### Embodiments

1. A corrosion-proof metallic liner made out of AISI 316 stainless steel with a tensile strength of at least 500 MPa and a carbon content below or equal to 0.08%, overwrapped by a structural composite carbon fiber-based with a tensile strength of 3,200 MPa or higher and a preferred Young Modulus of 230 GPa or higher, with advantageously 12,000, 24,000 or 48,000 filaments per yarn and a second external layer made out of non-reinforced epoxy resin with a tensile strength of at least 80 MPa and a thermal conductivity of about 0.2 W·m⁻¹·K⁻¹ for insulating reasons.
2. A corrosion-proof metallic liner made out of AISI 316 stainless steel with a tensile strength of at least 500 MPa and a carbon content below or equal to 0.08%, overwrapped by a structural composite carbon fiber-based with a tensile strength of 3,200 MPa or higher and a preferred Young Modulus of 230 GPa or higher, with advantageously 12,000, 24,000 or 48,000 filaments per yarn and a second external glass fiber-based composite layer with an E-glass or S-glass fiber with an suggested tensile strength of 1,000 MPa or higher and a suggested Young Modulus of 70 GPa or higher impregnated with an epoxy resin with a thermal conductivity of about 0.2 W·m⁻¹·K⁻¹ for insulating reasons.
3. A corrosion-proof metallic liner, overwrapped by a structural composite carbon fiber-based with a tensile strength of 3,200 MPa or higher and a preferred Young Modulus of 230 GPa or higher, with advantageously 12,000, 24,000 or 48,000 filaments per yarn and a second external glass fiber-based composite layer with an E-glass or S-glass fiber with an suggested tensile strength of 1,000 MPa or higher and a suggested Young Modulus of 70 GPa or higher impregnated with an epoxy resin with a thermal conductivity of about 0.2 W·m⁻¹·K⁻¹ for insulating reasons plus a third external layer made out of non-reinforced epoxy resin with a tensile strength of at least 80 MPa and a thermal conductivity of about 0.2 W·m⁻¹·K⁻¹ for insulating reasons. This configuration also allows the vessel to have a higher thermal stability, giving the transported gas a lower temperature gradient.

The pressure vessels described herein can carry a variety of gases, such as raw gas straight from a bore well, including raw natural gas, e.g. when compressed—raw CNG or RCNG, or H₂, or CO₂ or processed natural gas (methane), or raw or part processed natural gas, e.g. with CO₂ allowances of up to 14% molar, H₂S allowances of up to 1,000 ppm, or H₂ and CO₂ gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state, and other impurities/species.

No doubt many other effective alternatives will occur to the skilled person. It will be understood that the invention is not limited to the described embodiments and encompasses modifications apparent to those skilled in the art lying within the spirit and scope of the claims appended hereto.

1. A pressure vessel, in particular for compressed natural gas containment or transport, with a generally cylindrical shape over a majority of its length and at least, an opening for gas loading and offloading and for liquid evacuation, the vessel comprising:
a metallic liner;
a first fiber layer external and adjacent to the metallic liner, and
a second fiber layer external and adjacent to the first fiber layer, wherein the first and second fiber layers are made of different materials.

2. The pressure vessel according to claim 1, wherein the metallic liner is gas impermeable and corrosion resistant.

3. The pressure vessel according to claim 2, wherein the metallic liner is selected from the group comprising steel, stainless steel, nickel-based alloys, bi-phase steel, aluminum, titanium, titanium alloys.

4. The pressure vessel according to claim 1, wherein each of the fiber layers is made of fibers wound about the metallic liner.

5. The pressure vessel according to claim 1, wherein the first fiber layer comprises carbon fibers.

6. The pressure vessel according to claim 1, wherein the second fiber layer comprises glass fibers.

7. (canceled)

8. The pressure vessel according to claim 1, wherein the inner diameter is between 0.5 meters and 5 meters.

9. The pressure vessel according to claim 7, wherein the inner diameter is between 1.5 meters and 3.5 meters.

10. The pressure vessel according to claim 1, further comprising a manhole for entering and/or inspecting the interior of the vessel.

11. A module or compartment comprising a plurality of inspectable pressure vessels according to claim 1, the pressure vessels being interconnected for loading and offloading operations.

12. A method of storing or transporting gas onshore or offshore, in particular compressed natural gas, using at least one pressure vessel according to claim 1.

13. A vehicle for transporting gas, in particular compressed natural gas, comprising at least one vessel according to claim 1.

14. The vehicle according to claim 13, wherein the vehicle is a ship.

15. (canceled)

16. A method of storing or transporting gas onshore or offshore, in particular compressed natural gas, using at least one module according to claim 11.

17. A vehicle for transporting gas, in particular compressed natural gas, comprising at least one module according to claim 11.

18. The vehicle according to claim 17, wherein the vehicle is a ship.
